(19) United States
(12) Patent Application Publication
(10) Pub. No.: US 2023/0061829 A1
(43) Pub. Date: Mar. 2, 2023

(54) OUTLIER DETECTION APPARATUS AND METHOD

(71) Applicant: Hitachi, Ltd., Tokyo (JP)

(72) Inventors: Jana BACKHUS, Tokyo (JP); Mineyoshi MASUDA, Tokyo (JP)

(21) Appl. No.: 17/686,151

(22) Filed: Mar. 3, 2022

(30) Foreign Application Priority Data
Sep. 2, 2021 (JP) 2021-143534

(51) Int. Cl. G06F 11/34

(52) U.S. Cl. CPC G06F 11/3433; G06F 11/3447

(57) ABSTRACT

An outlier detection apparatus creates a first processing window having a designated window length and a second processing window having a designated window length, and performs sliding alignment for sliding the second processing window relative to the first processing window by a designated sliding alignment length. The apparatus performs one or more types of outlier sub-detections. The outlier sub-detection includes comparing, by a method corresponding to the type of outlier sub-detection, a real time series dataset which is a data portion corresponding to the first processing window from among real time series data which is a time series of real values, with a forecasted time series dataset which is a data portion corresponding to the second processing window after the sliding alignment from among forecasted time series data which is a time series of forecasted values. The apparatus decides whether an outlier candidate is an outlier.

### BACKGROUND OF THE INVENTION

### 1. Field of the Invention

The present invention generally pertains to a technique for detecting an outlier.

### 2. Description of the Related Art

As one method for automatically detecting an outlier from data regarding an information technology (IT) system, there is a method for modeling a performance load in the IT system, forecasting a performance load from the model, and comparing the forecasted performance load with a real performance load. In a case where the real performance load greatly deviates from the forecasted performance load, it is possible to detect an outlier which has a possibility of relating to an abnormality in the IT system.

For a detected outlier, it may be that what is generally called a noisy outlier, in other words, an outlier which has no relation to an actual abnormality in the IT system, is detected.

U.S. Pat. No. 10,261,851 discloses a technique for learning an outlier classifier on the basis of a feature amount extracted from implicit or explicit feedback data from a user and a situation-dependent time series pattern detector. The learned outlier classifier can reduce noisy outliers from among initially identified abnormal event candidates.

In the technique disclosed in U.S. Pat. No. 10,261,851, implicit or explicit feedback data from a user is necessary in order to learn the outlier classifier by supervised machine learning.

### SUMMARY OF THE INVENTION

An outlier detection apparatus includes an outlier detector and an outlier decider. The outlier detector has a window creator and one or a plurality of types of outlier sub-detectors. The window creator creates a first processing window having a designated window length and a second processing window having a designated window length, and performs sliding alignment for sliding the second processing window relative to the first processing window by a designated sliding alignment length. Each of one or more types of outlier sub-detectors from among the one or a plurality of types of outlier sub-detectors performs an outlier sub-detection which includes comparing, by a method corresponding to the type of the outlier sub-detector, a real time series dataset which is a data portion corresponding to the first processing window from among real time series data which is a time series of real values, with a forecasted time series dataset which is a data portion corresponding to the second processing window after the sliding alignment from among forecasted time series data which is a time series of forecasted values. The outlier decider decides whether an outlier candidate based on an outlier sub-detection result from the one or more types of outlier sub-detectors is an outlier.

Advantage of the Invention

By virtue of the present invention, it is possible to realize an outlier detection in which noise has been reduced, without supervised machine learning which requires feedback data from a user.

### BRIEF DESCRIPTION OF THE DRAWINGS

FIG. 1 is a view illustrating an example of a functional configuration of a noise reducing outlier detection apparatus according to an embodiment of the present invention;

FIG. 2A is a view illustrating an example of a configuration of a real time series data table in a time series DB;

FIG. 2B is a view illustrating an example of a configuration of a forecasted time series data table in the time series DB;

FIG. 3A is a view illustrating an example of a configuration of a parameter table in a parameter/threshold DB;

FIG. 3B is a view illustrating an example of a configuration of a threshold table in the parameter/threshold DB;

FIG. 4 is a flow chart illustrating an example of a flow of spiking load threshold calculation processing;

FIG. 5 is a flow chart illustrating an example of a flow for outlier detection processing;

FIG. 6 is a flow chart illustrating an example of a flow for S11002 in FIG. 5;

FIG. 7 is a flow chart illustrating an example of a flow for S11003 in FIG. 5;

FIG. 8 is a flow chart illustrating an example of a flow for S11004 in FIG. 5;

FIG. 9 is a flow chart illustrating an example of a flow for S11005 in FIG. 5;

FIG. 10A is a view illustrating an example of a configuration of a window outlier table in a log DB;

FIG. 10B is a view illustrating an example of a configuration of an outlier decision table in the log DB;

FIG. 10C is a view illustrating an example of a configuration of a threshold table in the log DB;

FIG. 11A is a portion of a flow chart illustrating an example of a flow for outlier decision processing;

FIG. 11B is the remainder of the flow chart illustrating the example of the flow for outlier decision processing;

FIG. 12 is a view illustrating an example of an outlier detection result screen;

FIG. 13 is a view illustrating an example of a hardware configuration of the noise reducing outlier detection apparatus;

FIG. 14 is an explanatory view of an example of the significance of a sliding alignment;

FIG. 15 is an explanatory view of an example of the significance of a point-based expected spike detection; and

FIG. 16 is an explanatory view of an example of the significance of a distribution-based expected spike detection.

### DESCRIPTION OF THE PREFERRED EMBODIMENT

In the following description, “interface apparatus” may be one or more interface devices. The one or more interface devices may be at least one of the following.

One or more input/output (I/O) interface devices. An I/O interface device is an interface device with respect to at least one of an I/O device and a remote computer for display. An I/O interface device for a computer for display may be a communication interface device. At least one I/O device is a user interface device, and, for example, may be any of an input device such as a keyboard and a pointing device, or an output device such as a display device.

One or more communication interface devices. The one or more communication interface devices may be one or more of the same kind of communication interface device (for example, one or more network interface cards (NICs)), or may be two or more different kinds of communication interface devices (for example, a NIC and a host bus adapter (HBA)).

In addition, in the following description, “memory” is one or more memory devices which are an example of one or more storage devices, and typically may be a main storage device. At least one memory device in a memory may be a volatile memory device, or may be a non-volatile memory device.

In addition, in the following description, “auxiliary storage apparatus” may be one or more auxiliary storage devices which are an example of one or more storage devices. An auxiliary storage device typically may be a non-volatile storage device (for example, an auxiliary storage device), and specifically, for example, may be a hard disk drive (HDD), a solid state drive (SSD), a Non-Volatile Memory Express (NVMe) drive, or a storage class memory (SCM).

In addition, in the following description, “storage apparatus” may be at least a memory from among a memory and an auxiliary storage apparatus.

In addition, in the following description, “processor” may be one or more processor devices. At least one processor device typically may be a microprocessor device such as a central processing unit (CPU), but may be another type of processor device such as a graphics processing unit (GPU). At least one processor device may have a single core or may have multiple cores. At least one processor device may be a processor core. At least one processor device may be a processor device in a broad sense, such as a circuit (for example, a field-programmable gate array (FPGA), a complex programmable logic device (CPLD), or an application-specific integrated circuit (ASIC)) which is an aggregate of gate arrays that performs some or all processing with use of a hardware description language.

In addition, in the following description, information for which output is obtained with respect to input is described with the expression “xxx DB” or “xxx table” (“DB” is an abbreviation for database) in some cases, but this information may be data having any structure (for example, may be structured data or unstructured data), or may be a learning model that generates an output with respect to an input, the learning model as represented by a neural network. Accordingly, “xxx DB” or “xxx table” can be referred to as “xxx information.” In addition, in the following description, the configuration of each DB or each table is an example, and one DB or one table may be divided into two or more DBs or two or more tables, or the entirety or a portion of two or more DBs or two or more tables may be one DB or one table.

In addition, in the following description, a function may be described as a “ detector” or an “outlier decider,” for example, but a function may be realized by a processor executing one or more computer programs, may be realized by one or more hardware circuits (for example, an FPGA or an ASIC), or may be realized by a combination of these. In a case where a function is realized by a processor executing a program, because defined processing is performed while appropriately using a storage apparatus and/or an interface apparatus, or the like, the function may be set as at least a portion of a processor. Processing described with a function as a subject may be said to be processing performed by a processor or an apparatus which has the processor. A program may be installed from a program source. A program source may be a recording medium (for example, a non-transitory recording medium) that can be read by a computer, or may be a program distribution computer, for example. Description of each function is an example, and a plurality of functions may be combined into one function, or one function may be divided into a plurality of functions.

An embodiment is described below with reference to the drawings. Note that the embodiment described below do not limit the invention set forth in the claims. Further, various components described in the embodiment and combinations thereof are not necessarily essential to the present invention.

In the description of the embodiment, it may be that an “outlier” is where there is a sufficient difference between two types of data which are compared with each other. It may be that, from among the two types of data, one type of data (forecasted time series data which is described below) represents an expected state (for example, a normal state) and the other type of data (real time series data which is described below) represents a current state.

A “noisy outlier” may be where there is a sufficient difference between two types of data which are compared with each other. However, it may be that, from among these two types of data, one type of data represents an expected normal state but the other type of data represents the current state which arises due to expected fluctuations in the normal state which cannot be accurately represented in data representing the normal state, and the other type of data may be data which should not be viewed as a problem.

“Real time series data” may be one type of measurement data representing a current state obtained for a monitoring target such as an IT system (for example, a physical or logical computing system). In the present embodiment, real time series data is a time series of measured values (an example of a real value) for a performance load, but measured values in a time series may be measured values for data items other than a performance load (for example, temperature or humidity).

“Forecasted time series data” may be one type of measurement data representing a forecasted state (for example, a normal state). In the present embodiment, forecasted time series data is a time series of forecasted values for a performance load. The forecasted values in time series, similarly to measured values, may be forecasted values for a data item other than a performance load.

An “expected spike” may be a time period in which a value for a performance load is particularly high among forecasted time series data.

A “distance” may indicate a scale at which a difference between real time series data and forecasted time series data can be quantified.

A “direction” may indicate a scale for evaluating whether real time series data has a value that is larger or smaller than that of forecasted time series data.

A “processing window” indicates any time period for outputting an outlier result after real time series data and forecasted time series data, from among time series data, are compared with each other. The length of a processing window may be the length of an amount of time, for example.

A “time series dataset” may be, from among time series data, data in a range corresponding to a processing window.

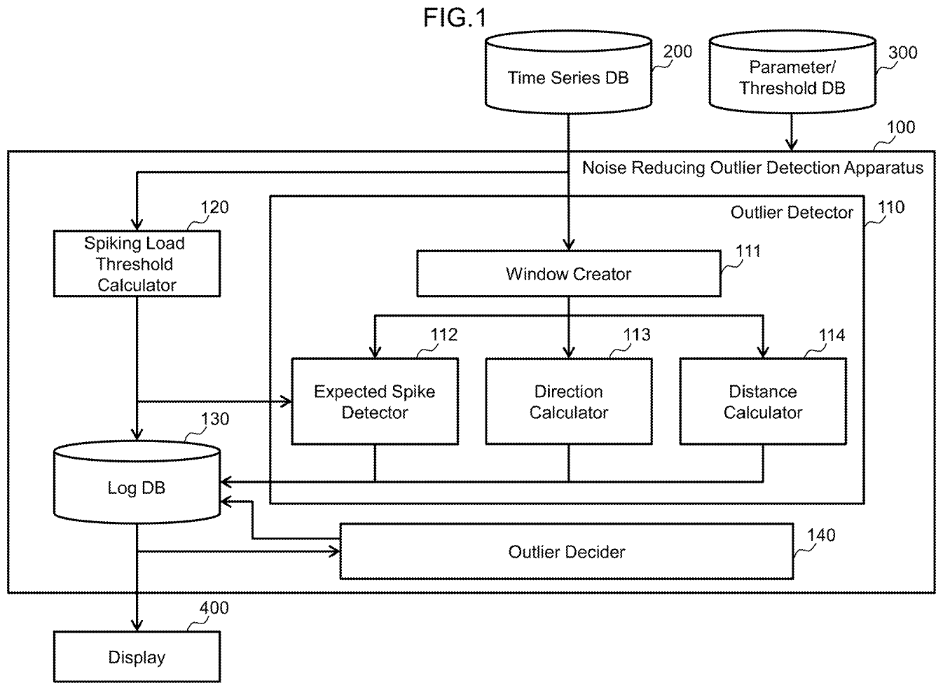

FIG. 1 illustrates an example of a functional configuration of a noise reducing outlier detection apparatus according to an embodiment of the present invention.

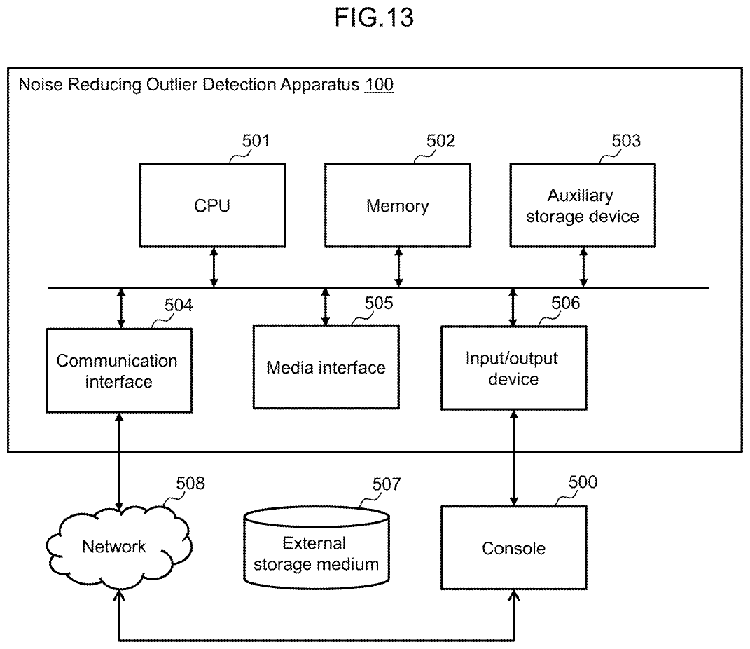

A noise reducing outlier detection apparatus 100 is an apparatus for performing an outlier detection in which noise has been reduced. The noise reducing outlier detection apparatus 100 may be a physical computer system (one or more physical computers) having a hardware configuration exemplified in FIG. 13, but may be a logical computer system (for example, a cloud computing service system) based on a physical computer system (for example, cloud infrastructure).

The noise reducing outlier detection apparatus 100 obtains real time series data and forecasted time series data which are stored in a time series DB 200 as well as parameters and thresholds which are stored in a parameter/threshold DB 300, compares the real time series data and the forecasted time series data to thereby detect an outlier, and visualizes, on a display 400, an output result which includes the outlier.

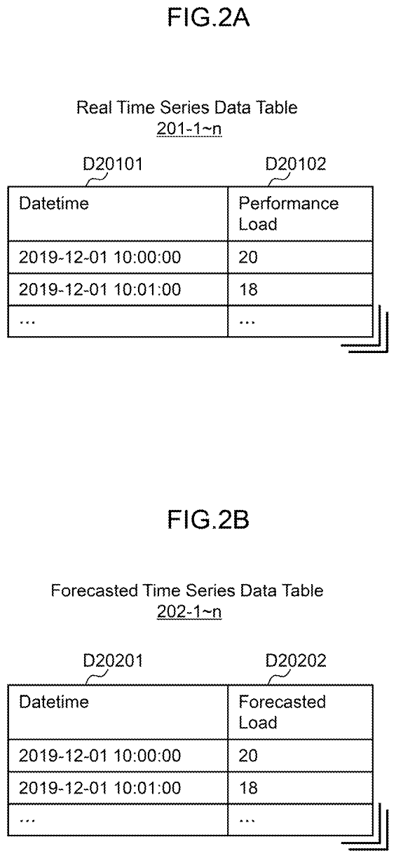

The time series DB 200 stores real time series data and forecasted time series data. Note that details are described later with reference to FIG. 2A and FIG. 2B.

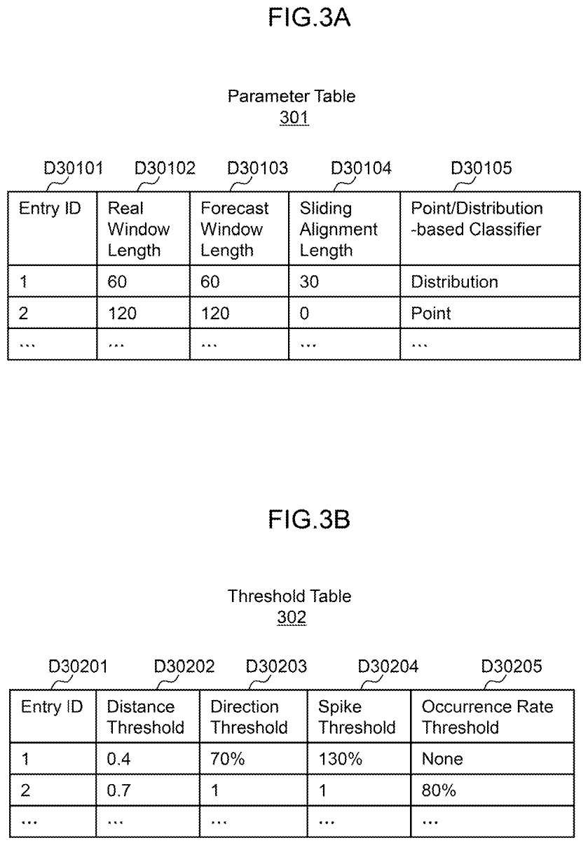

The parameter/threshold DB 300 stores a parameter table and a threshold table which are defined from an external unit by a user of the noise reducing outlier detection apparatus 100. Note that details are described later with reference to FIG. 3A and FIG. 3B.

The display 400 is an output apparatus for visualizing a result obtained by the noise reducing outlier detection apparatus 100.

The noise reducing outlier detection apparatus 100 includes an outlier detector 110, a spiking load threshold calculator 120, a log DB 130, and an outlier decider 140. The outlier detector 110 includes a window creator 111, an expected spike detector 112, a direction calculator 113, and a distance calculator 114.

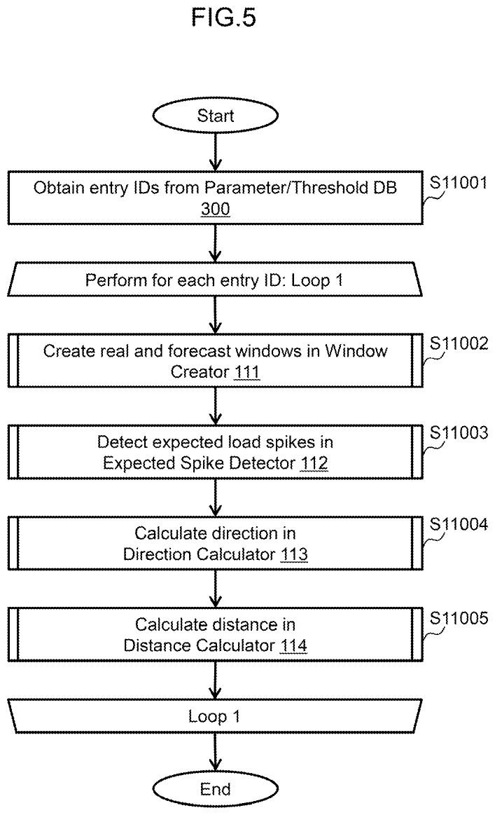

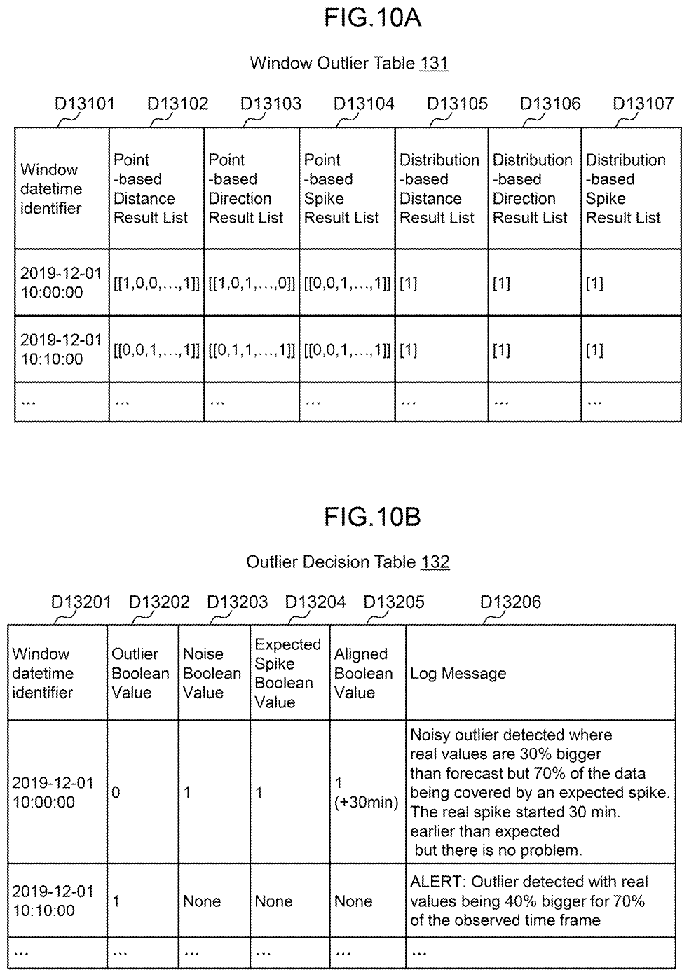

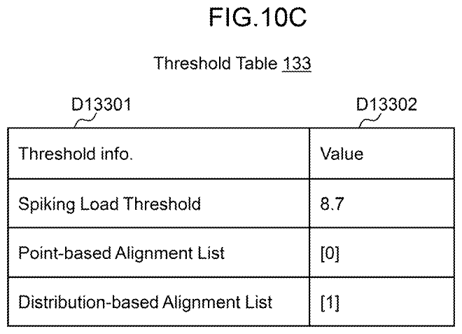

The noise reducing outlier detection apparatus 100 firstly, in the outlier detector 110, processes obtained real time series data and forecasted time series data. Specifically, for example, the outlier detector 110 divides each of the real time series data and the forecasted time series data into a plurality of processing windows (plurality of time series datasets) with use of the window creator 111, and calculates the possibility of an outlier in each real time series dataset with use of three types of outlier sub-detectors 112 through 114. A result obtained by this processing is stored in the log DB 130. For further details, the outlier detector 110 is described later with reference to FIG. 5 through FIG. 9, and the log DB 130 is described later with reference to FIGS. 10A and 10B.

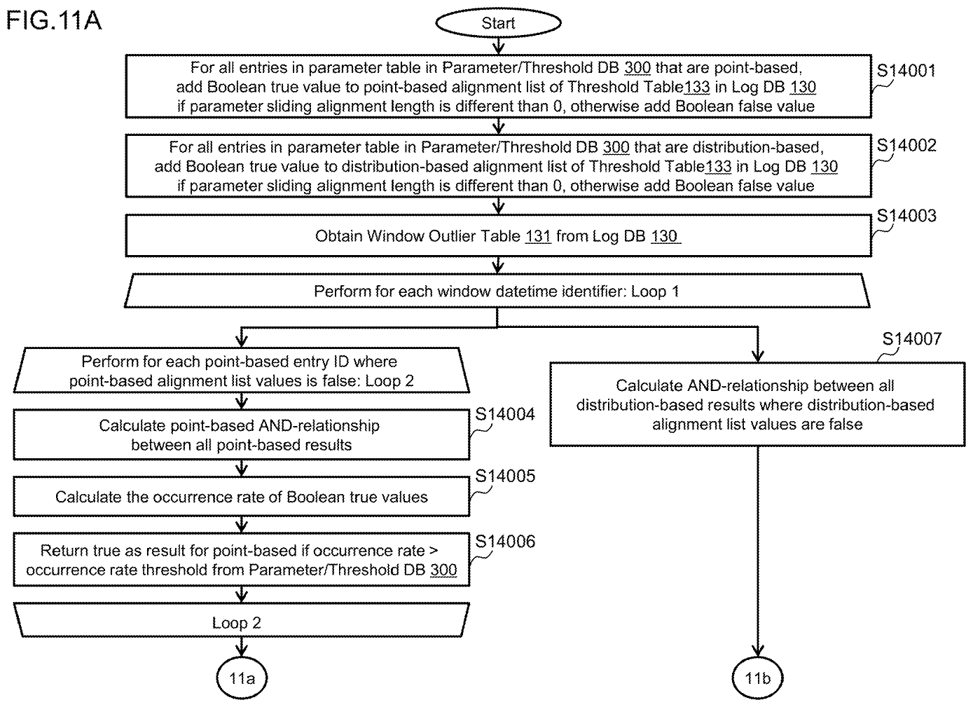

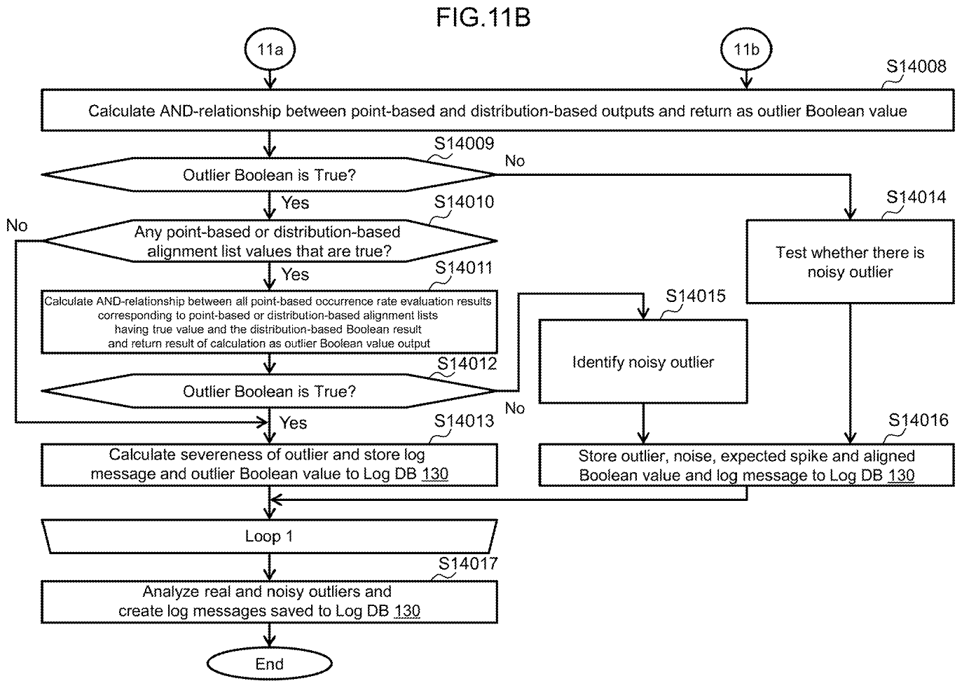

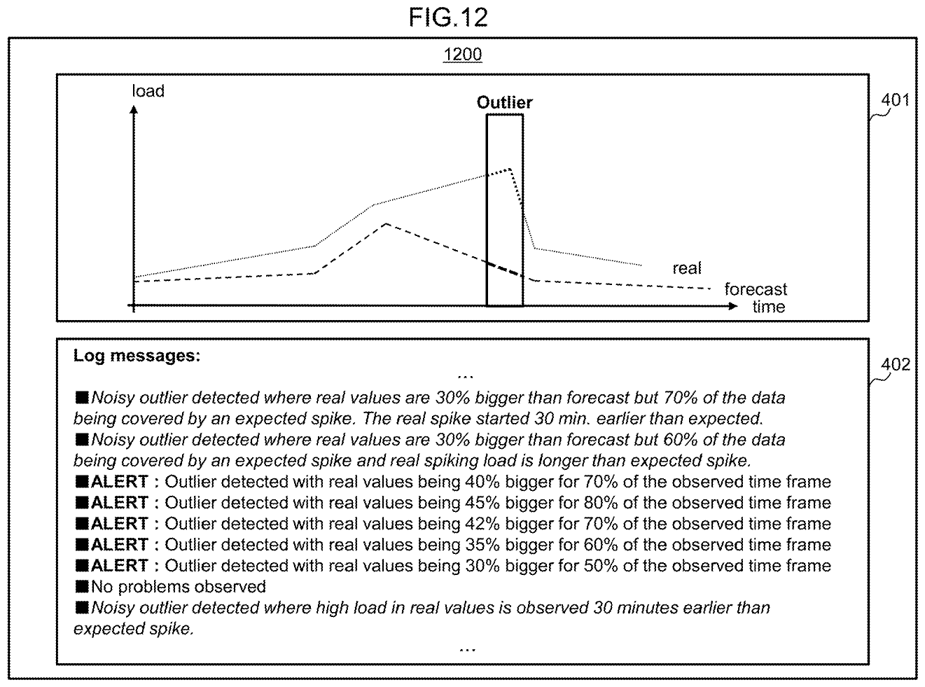

An output obtained from the outlier detector 110 and stored in the log DB 130 is processed by the outlier decider 140. In other words, a final decision on an outlier is performed by the outlier decider 140 on the basis of results from the outlier sub-detectors 112 through 114. If necessary, a log message is created by the outlier decider 140. A final outlier and log message are stored in the log DB 130 and subsequently visualized on the display 400. For further details, the outlier decider 140 is described later with reference to FIGS. 11A and 11B, and an example of a configuration of a screen displayed on the display 400 is described later with reference to FIG. 12.

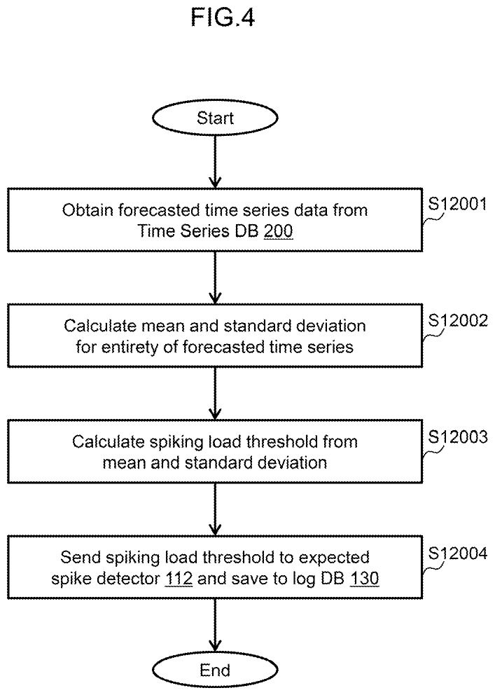

The forecasted time series data is further processed by the spiking load threshold calculator 120 which calculates a threshold for an expected spike. A result of this processing is stored in the log DB 130. Further details are described later with reference to FIG. 4.

By virtue of the noise reducing outlier detection apparatus 100, it is possible to realize an outlier detection in which noise has been reduced, without supervised machine learning which requires feedback data from a user.

The time series DB 200 stores a real time series data table 201 which is exemplified in FIG. 2A and a forecasted time series data table 202 which is exemplified in FIG. 2B.

The real time series data table 201, as exemplified in FIG. 2A, stores a time series for a real performance load (measured values for performance load), in other words, stores real time series data. The real time series data table 201 includes columns such as a datetime D20101 and a performance load D20102. The datetime D20101 stores a real datetime (for example, a time stamp which represents the datetime) which is the datetime at which the performance load was measured. A unit for a “datetime” is year, month, day, hour, minute, second in the present embodiment, but may be a unit which is coarser or finer than this, or may be a different unit. The performance load D20102 stores a measured value for a performance load (for example, a number obtained from data representing performance metrics of an IT system which is being monitored).

The forecasted time series data table 202, as exemplified in FIG. 2B, stores a time series for a forecasted performance load (forecasted values for a performance load), in other words, stores forecasted time series data. The forecasted time series data table 202 includes columns such as a datetime D20201 and a forecasted load D20202. The datetime D20201 stores a forecast datetime (for example, a time stamp which represents the datetime) which is the datetime at which the forecasted performance load is forecasted to be measured. The forecasted load D20202 stores a value which is forecasted as the performance load. The forecasted time series data may be obtained by a freely-defined method. For example, the forecasted time series data may be data outputted from a machine learning model (for example, a neural network) due to the machine learning model being inputted with at least some pieces of time series data from among real time series data and past time series data (for example, past real time series data or forecasted time series data obtained in the past (forecasted time series data for which the forecast datetime is a past datetime)). The forecasted time series data may also be data resulting from processing data obtained from this machine learning model. Alternatively, the forecasted time series data may be data manually prepared on the basis of past time series data or other data.

The parameter/threshold DB 300 stores a parameter table 301 exemplified in FIG. 3A and a threshold table 302 exemplified in FIG. 3B.

The parameter table 301 stores defined parameters, as illustrated in FIG. 3A. The parameter table 301 includes columns such as an entry identification (ID) D30101, a real window length D30102, a forecast window length D30103, a sliding alignment length D30104, and a point/distribution-based classifier D30105, for example. In one entry (row), values stored in the columns D30102 through D30105 are each a parameter.

The entry ID D30101 stores an ID for an entry.

The real window length D30102 stores (a number representing) a real window length which is the length of a real window (a processing window for real time series data). A real window length may be represented by an amount of time (for example, in units of minutes or seconds), for example.

The forecast window length D30103 stores (a number representing) a forecast window length which is the length of a forecast window (a processing window for forecasted time series data). In one entry, the forecast window length may be the same as or different to the real window length in the same entry. In a case where the real window length and the forecast window length differ, a predetermined technique may be used (for example, a technique called dynamic time warping may be used in a distance calculation).

The sliding alignment length D30104 stores (a number representing) a sliding alignment length which is the length of an alignment time difference (deviation) between a real window and a forecast window. The sliding alignment length may be represented by an amount of time (for example, in units of minutes or seconds), for example. Details of the sliding alignment length are as described below.

A sliding alignment length “0” means that there is no deviation between the real window and the forecast window. In other words, a start datetime for the real window (for example, a window datetime identifier described below) is the same datetime as the start datetime for the forecast window.

The sliding alignment length having a negative value means sliding the forecast window relatively into the past with respect to the real window. For example, a sliding alignment length of “−30” means that the start datetime of the forecast window is 30 time steps (for example, 30 seconds) earlier than the start datetime of the real window.

The sliding alignment length having a positive value means sliding the forecast window relatively into the future with respect to the real window. For example, a sliding alignment length of “30” means that the start datetime of the forecast window is 30 time steps (for example, 30 seconds) later than the start datetime of the real window.

The point/distribution-based classifier D30105 stores a classifier (a value such as a “point” or a “distribution,” for example) representing which of point-based processing or distribution-based processing to be used in an outlier detection.

The threshold table 302 stores defined thresholds, as illustrated in FIG. 3B. The threshold table 302 includes columns such as an entry ID D30201, a distance threshold D30202, a direction threshold D30203, a spike threshold D30204, and an occurrence rate threshold D30205, for example.

The entry ID D30201 stores an ID for an entry. An entry (row) in the threshold table 302 corresponds at 1:1 with an entry in the parameter table 301. Accordingly, for example, with the entry ID “1” as a key, a parameter table entry storing the entry ID “1” and a threshold table entry storing the entry ID “1” are specified. Various thresholds corresponding to the entry ID “1” are used for processing using various parameters corresponding to the entry ID “1.”

The distance threshold D30202 stores a distance threshold which is a threshold for a distance between a real time series dataset and a forecasted time series dataset. It may be that, in a case where there is no need to calculate the distance for an evaluation of an outlier candidate, the distance threshold is unnecessary (for example, undefined).

The direction threshold D30203 stores a direction threshold which is a threshold for a direction between a real time series dataset and a forecasted time series dataset. A “direction” depends on whether or not there are relatively more real performance loads larger than forecasted performance loads between a real time series dataset and a forecasted time series dataset, for example. A direction threshold may be any threshold, in alignment with a direction calculation method which is used. It may be that, in a case where the direction is already obtained in a distance calculation or in a case where calculating direction is not necessary to evaluate an outlier candidate, the direction threshold is unnecessary (for example, is undefined (for example, is a value such as “0”)).

The spike threshold D30204 stores a spike threshold which is a threshold for an expected spike. An expected spike is specified from a forecasted time series dataset and is used to evaluate an outlier candidate. It may be that, in a case where an expected spike is not necessary to evaluate an outlier candidate, the spike threshold is unnecessary (for example, undefined (for example, is a value such as “0”)).

The occurrence rate threshold D30205 stores an occurrence rate threshold which is a threshold for the occurrence rate (ratio of true values among all Boolean values) of true values obtained in point-based processing. It may be that, in the case where processing corresponding to the entry is distribution-based processing, the occurrence rate threshold in the entry is unnecessary (for example, undefined (for example, is a value such as “None”)).

An example of processing performed in the present embodiment is described below.

FIG. 4 is a flow chart illustrating an example of a flow of spiking load threshold calculation processing. The spiking load threshold calculation processing is performed by the spiking load threshold calculator 120.

In S12001, the spiking load threshold calculator 120 obtains forecasted time series data from the time series DB 200.

In S12002, the spiking load threshold calculator 120 calculates a mean and a standard deviation for the entirety of the forecasted time series data obtained in S12001.

In S12003, the spiking load threshold calculator 120 calculates a spiking load threshold from the mean and standard deviation obtained in step S12002. An example of a spiking load threshold is a value obtained by adding k times the standard deviation to the mean.

In S12004, the spiking load threshold calculator 120 sends the spiking load threshold calculated in S12003 to the expected spike detector 112, and saves the spiking load threshold in the log DB 130.

The spiking load threshold may be decided based on forecasted time series data in this manner. The forecasted time series data is based on past time series data and corresponds to expected real time series data (expected values for real time series data). Therefore, at what timing is a spike expected is automatically calculated by the spiking load threshold calculator 120 on the basis of such forecasted time series data. Note that the spiking load threshold may be manually set.

FIG. 5 is a flow chart illustrating an example of a flow for outlier detection processing. The outlier detection processing is performed by the outlier detector 110. Note that real time series data and forecasted time series data in this processing may be obtained by the outlier detector 110 from the time series DB 200, for example, at any timing. In addition, real time series data and forecasted time series data include data for the same time period.

In S11001, the outlier detector 110 obtains all entry IDs which are defined in the parameter/threshold DB 300. The following S11002 through S11005 is executed for each entry ID obtained in S11001. S11002 through S11005 are described by taking one entry ID as an example.

In S11002, the window creator 111 creates real windows (an example of first processing windows) and forecast windows (an example of second processing windows).

In S11003, the expected spike detector 112 detects expected load spikes.

In S11004, the direction calculator 113 calculates a direction.

In S11005, the distance calculator 114 calculates a distance.

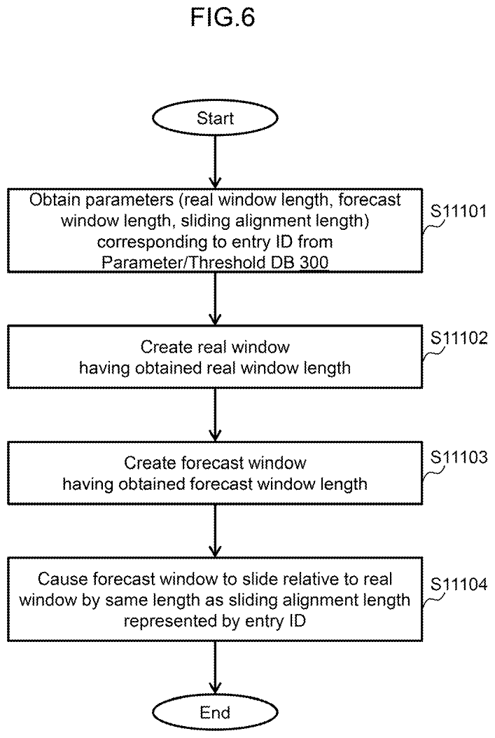

FIG. 6 is a flow chart illustrating an example of a flow for S11002 in FIG. 5.

In S11101, the window creator 111 obtains parameters (real window length, forecast window length, sliding alignment length) corresponding to the entry ID from the parameter/threshold DB 300.

In S11102, the window creator 111 creates a real window (for example, a rolling window). The length of the real window is the real window length obtained in S11101.

In S11103, the window creator 111 creates a forecast window (for example, a rolling window). The length of the forecast window is the forecast window length obtained in S11101.

In S11104, the window creator 111 causes the forecast window to slide relative to the real window by the same length as the sliding alignment length represented by the entry ID. In this manner, the window creator 111 performs a sliding alignment which is causing the forecast window to slide relative to the real window.

A plurality of time periods corresponding to a plurality of real time series datasets obtained using a real window may be consecutive time periods which do not overlap with each other, but some time periods may overlap with each other. For example, in a case where the real window length is “30” data points, it may be that data corresponding to 30 data points from the head of real time series data is a leading real time series dataset (a leading real window) and data corresponding to the next 30 data points is the next real time series dataset (the next real window). From among real time series data, data in a range which corresponds to a real window is a real time series dataset. A plurality of real time series datasets are obtained using a real window. Therefore, it can be said that there is a real window for each real time series dataset. A start datetime for each real window is the start datetime for the real time series dataset corresponding to the real window.

A plurality of time periods corresponding to a plurality of forecasted time series datasets obtained using a forecast window may be consecutive time periods which do not overlap with each other, but some time periods may overlap with each other. From among forecasted time series data, data in a range which corresponds to a forecast window is a forecasted time series dataset. A plurality of forecasted time series datasets are obtained using a forecast window. Therefore, it can be said that there is a forecast window for each forecasted time series dataset. A start datetime for each forecast window is the start datetime for the forecasted time series dataset corresponding to the forecast window.

The real window created in S11102 and the forecast window created in S11103 make up a window set (a pair of windows). Accordingly, the real time series dataset corresponding to the real window and the forecasted time series dataset corresponding to the forecast window make up a pair, and a comparison is performed across the datasets which make up the pair.

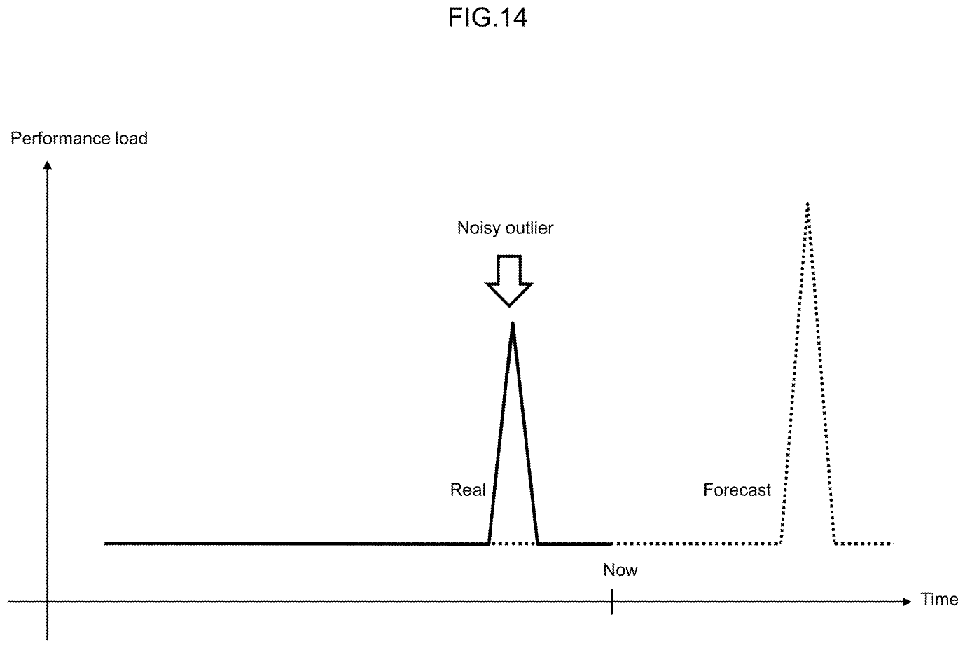

An example of the significance of sliding alignment is as illustrated in FIG. 14, for example. If the start of predetermined processing (for example, batch processing) in an IT system is as scheduled, a spike should occur at the datetime as in the forecasted time series data indicated by a broken line. However, as in real time series data indicated by a solid line, a spike arises at a datetime which is earlier than the expected datetime for the spike, due to a cause such as the start of the predetermined processing being earlier than scheduled. In one comparative example, a spike which occurs at a datetime which differs to the expected datetime for the spike can be detected as an outlier. This is because there is a large difference between the real performance load and the forecasted performance load at this datetime. However, this outlier is a noisy outlier. This is because, although the occurrence datetime differs, the occurrence of an expected spike is not an abnormality. In the present embodiment, the sliding alignment described above is performed, whereby it is possible to relatively overlap an expected datetime for a spike and a real datetime for a spike and thereby avoid detecting such a spike (noisy outlier) as an outlier, in other words, it is possible to reduce noise.

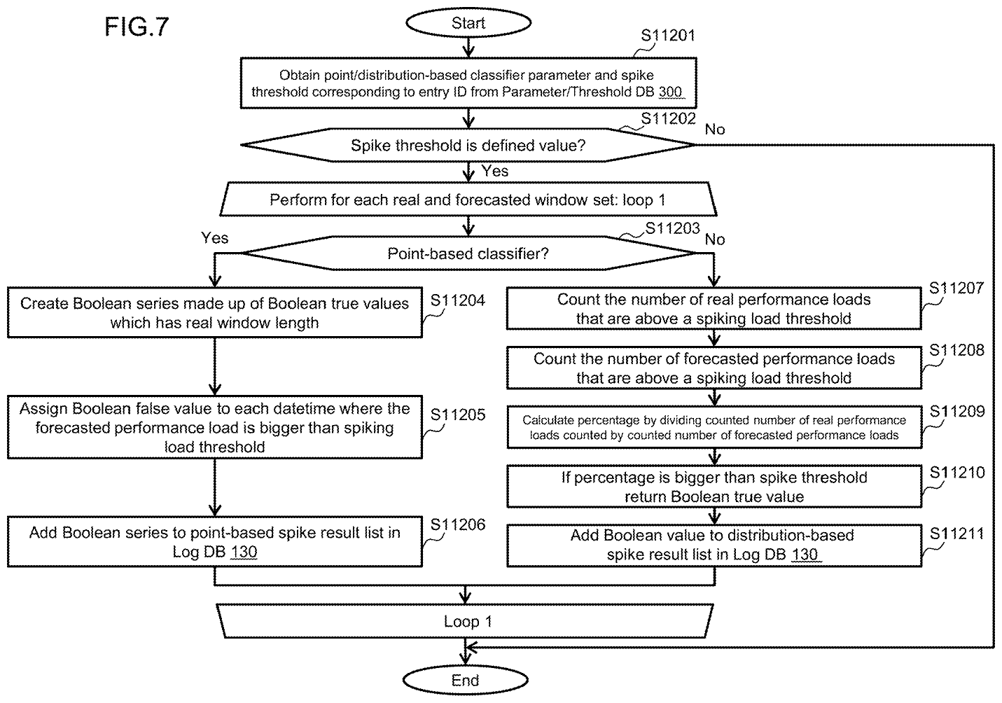

FIG. 7 is a flow chart illustrating an example of a flow for S11003 in FIG. 5.

In S11201, the expected spike detector 112 obtains, from the parameter/threshold DB 300, the point/distribution-based classifier and the spike threshold corresponding to the entry ID.

In S11202, the expected spike detector 112 decides whether or not the spike threshold obtained in S11201 is a defined value. In a case where the decision result is Yes, the processing proceeds to S11203. In a case where the decision result is No (for example, in a case where a value for the spike threshold is an undefined value), the processing ends.

S11203 through S11211 are executed for each window set (pair) of a real window and a forecast window. In the description of S11203 through S11211, one window set is taken as an example. Note that, for the window set, the sliding alignment length for the real window and the forecast window may be zero, may be less than zero (a negative value), or may be greater than zero (a positive value). Accordingly, for one window set, the datetime for the real window (real time series dataset) and the datetime for the forecast window (forecasted time series dataset) “corresponding” means that these datetimes are the same datetime (for example, both are “2019Dec. 1 10:00:00”) or that these datetimes are datetimes that are relatively deviated by the sliding alignment length (for example, one datetime is “2019 Dec. 1 10:00:00” and the other datetime is “2019 Dec. 1 10:00:30”). Accordingly, the correspondence between a real performance load and a forecasted performance load (in other words, the difference between the real datetime for the real performance load and the forecast datetime for the forecasted performance load) also conforms with the sliding alignment length (a time difference).

In S11203, the expected spike detector 112 decides whether or not the point/distribution-based classifier obtained in S11201 is a “point.” In a case where the decision result is Yes, S11204 through S11206 are executed. In a case where the decision result is No (in other words, in a case where the point/distribution-based classifier obtained in S11201 is a “distribution”), S11207 through S11211 are executed.

In S11204, the expected spike detector 112 creates a Boolean series made up of Boolean true values (in other words, a Boolean series in which all Boolean values are the true value “1”). The Boolean series has the length of the real window length, and is made up by a plurality of

Boolean values corresponding to a plurality of datetimes which configure a time period for the real window length.

In S11205, for each of the plurality of datetimes corresponding to the Boolean series created in S11204, the expected spike detector 112 assigns a Boolean false value to the datetime in the case where the forecasted performance load (a forecasted performance load in the forecasted time series dataset) for the expected datetime corresponding to the datetime has a value larger than the spiking load threshold. In other words, from among the Boolean series, a Boolean value corresponding to a forecasted performance load larger than the spiking load threshold changes to a Boolean false value.

In S11206, the expected spike detector 112 adds the Boolean series after the processing in S11205 to the log DB 130 (point-based spike result list in the window outlier table 131).

In S11207 in FIG. 7, the expected spike detector 112 counts the number of real performance loads which exceed the spiking load threshold, from among the real time series dataset.

In S11208, the expected spike detector 112 counts the number of forecasted performance loads which exceed the spiking load threshold, from among the forecasted time series dataset.

In S11209, the expected spike detector 112 calculates a percentage by dividing the number of real performance loads counted in S11207 by the number of forecasted performance loads counted in S11208.

In S11210, the expected spike detector 112 returns a Boolean true value in a case where the percentage calculated in S11209 is greater than the spike threshold obtained in S11201. In contrast, in a case where the percentage calculated in S11209 is less than or equal to the spike threshold obtained in S11201, the expected spike detector 112 returns a Boolean false value.

In S11211, the expected spike detector 112 adds the Boolean value (value returned in S11210) to the log DB 130 (distribution-based spike result list in the window outlier table 131).

In the above manner, the expected spike detector 112 performs a point-based or distribution-based outlier sub-detection from a perspective of an expected spike detection. With the distribution-based approach, a dataset (a data portion corresponding to a window) from among time series data is treated as one group (collection). Specifically, when comparing a real time series dataset and a forecasted time series dataset, instead of comparing the performance load for each time, there is a comparison between the number of real performance loads (real performance loads exceeding the spiking load threshold) and the number of forecasted performance loads (forecasted performance loads exceeding the spiking load threshold). The spiking load threshold is a threshold calculated from forecasted time series data, and the forecasted time series data is data which represents a normal state and is compared with real time series data. Accordingly, an appropriate distribution-based expected spike detection is expected.

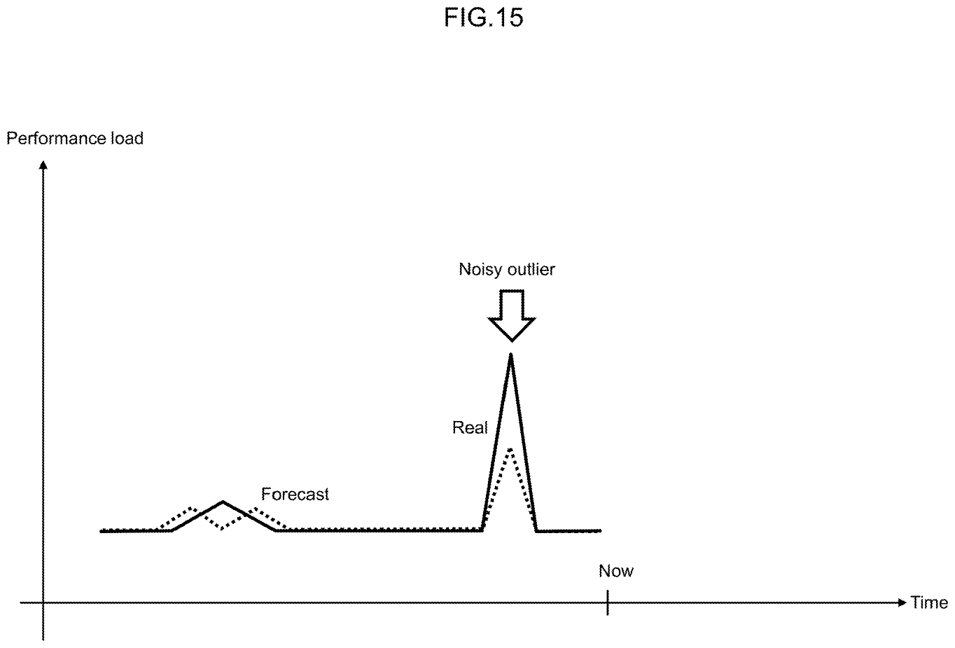

An example of the significance of a point-based expected spike detection is as illustrated in FIG. 15. Typically, a forecasted performance load is based on, for example, a mean of past real performance loads, and thus has a tendency of being smaller than a real performance load spike. Accordingly, even if a real performance load has a large difference with a forecasted performance load to the extent that this difference can be detected as a spike, if the forecasted performance load is greater than the spiking load threshold, the spike is a scheduled spike and thus is a noisy outlier. By virtue of the point-based expected spike detection according to S11204 through S11206, it is possible to reduce the possibility of detecting such a noisy outlier as an outlier.

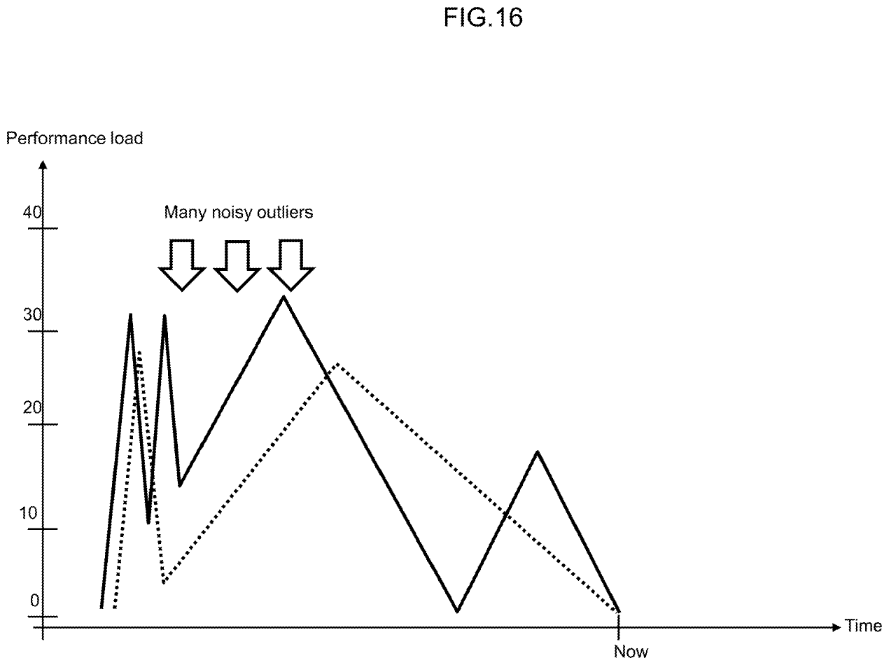

An example of the significance of a distribution-based expected spike detection is as illustrated in FIG. 16. It is possible that there is a large number of datetimes at which the difference between a real performance load and the forecasted performance load corresponding thereto is large enough to be decided to be a spike. However, in a case where such a large difference has arisen due to a reason known in advance such as low accuracy of a forecasted time series dataset, there is a high possibility for a real performance load attributed to such a difference being a noisy outlier. By virtue of the distribution-based expected spike detection according to S11207 through S11211, it is possible to reduce the possibility of detecting many noisy outliers pertaining to many of such differences as outliers.

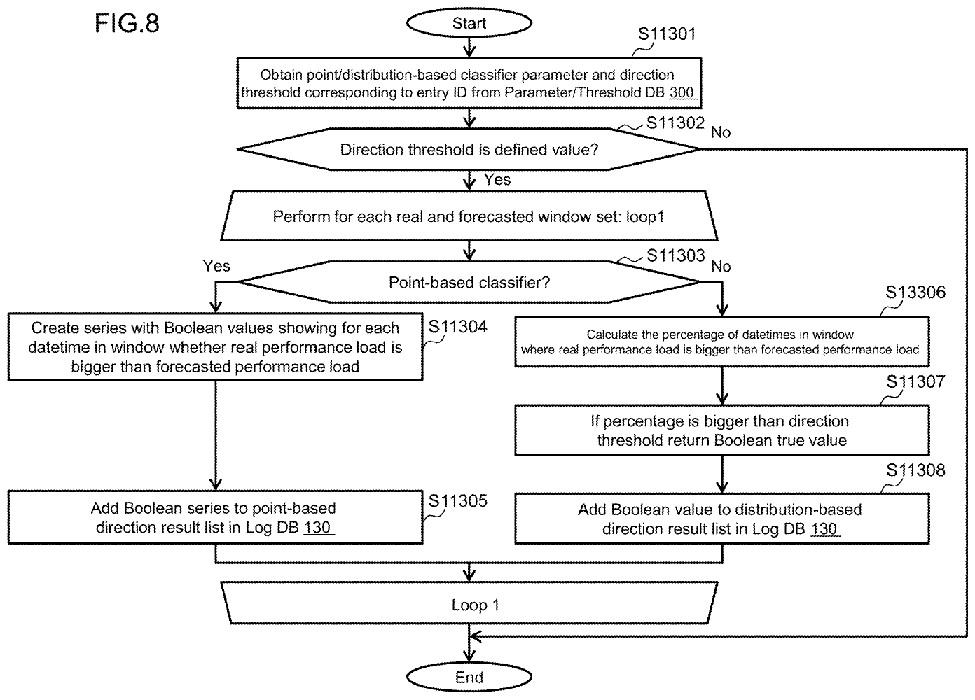

FIG. 8 is a flow chart illustrating an example of a flow for S11004 in FIG. 5.

In S11301, the direction calculator 113 obtains, from the parameter/threshold DB 300, the point/distribution-based classifier and the direction threshold corresponding to the entry ID.

In S11302, the direction calculator 113 decides whether or not the direction threshold is a defined value. In a case where the decision result is Yes, the processing proceeds to S11303. In a case where the decision result is No, the processing ends.

S11303 through S11308 are executed for each window set which has a real window and a forecast window. In the description of S11303 through S11308, one window set is taken as an example.

In S11303, the direction calculator 113 decides whether or not the point/distribution-based classifier is a “point.” In a case where the decision result is Yes, S11304 and S11305 are executed. In a case where the decision result is No, S11306 through S11308 are executed.

In S11304, the direction calculator 113 creates a Boolean series made up of Boolean values. The Boolean series has the length of the real window length, and is made up by a plurality of Boolean values corresponding to a plurality of datetimes which configure a time period for the real window length. For each of the plurality of datetimes, the Boolean value corresponding to the datetime is a true value if the real performance load is greater than the forecasted performance load corresponding thereto, and the Boolean value corresponding to the datetime is a false value if the real performance load is less than or equal to the forecasted performance load corresponding thereto.

In S11305, the direction calculator 113 adds the Boolean series created in S11304 to the log DB 130 (point-based direction result list in the window outlier table 131).

In S11306, the direction calculator 113 calculates a percentage for the number of datetimes where the real performance load is greater than the forecasted performance load, with respect to the number of datetimes which make up the time period for the processing window length.

In S11307, the direction calculator 113 returns a Boolean true value in a case where the percentage calculated in S11306 is greater than the direction threshold obtained in S11301. In contrast, in a case where the percentage calculated in S11306 is less than or equal to the direction threshold obtained in S11301, the direction calculator 113 returns a Boolean false value.

In S11308, the direction calculator 113 adds the Boolean value returned in S11307, to the log DB 130 (distribution-based direction result list in the window outlier table 131).

In the above manner, the direction calculator 113 performs a point-based or distribution-based outlier sub-detection from the perspective of the direction of the difference between a real time series dataset and a forecasted time series dataset (whether or not there is a general trend for the real time series dataset being larger than the forecasted time series dataset).

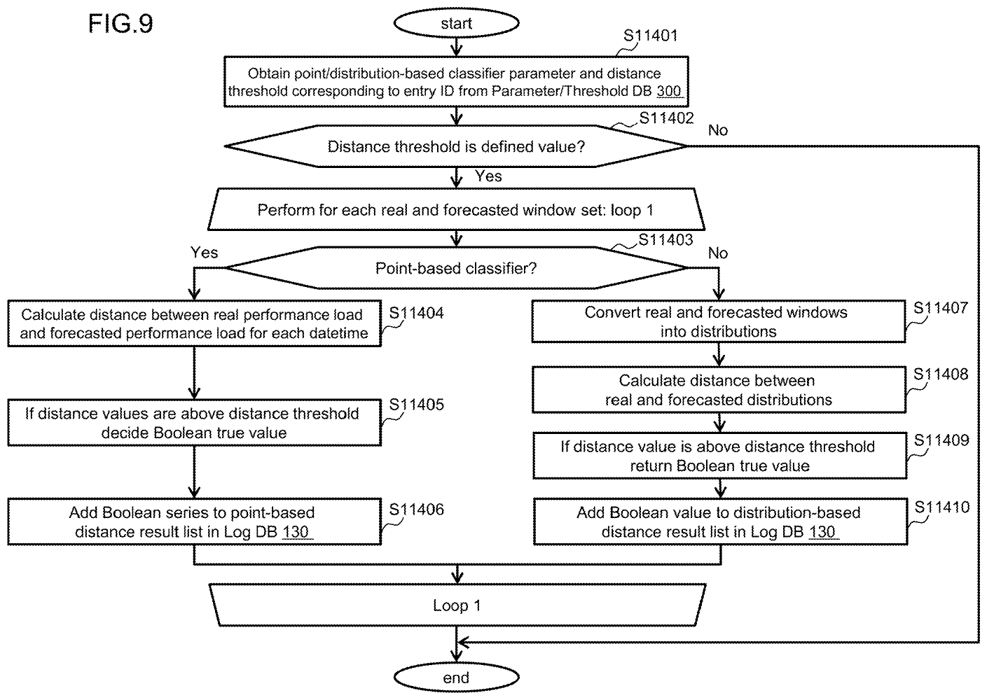

FIG. 9 is a flow chart illustrating an example of a flow for S11005 in FIG. 5.

In S11401, the distance calculator 114 obtains, from the parameter/threshold DB 300, the point/distribution-based classifier and the distance threshold corresponding to the entry ID.

In S11402, the distance calculator 114 decides whether or not the distance threshold obtained in S11401 is a defined value. In a case where the decision result is Yes, the processing proceeds to S11403. In a case where the decision result is No, the processing ends.

S11403 through S11410 are executed for each window set which has a real window and a forecast window. In the description of S11403 through S11410, one window set is taken as an example.

In S11403, the distance calculator 114 decides whether or not the point/distribution-based classifier is a “point.” In a case where the decision result is Yes, S11404 through S11406 are executed. In a case where the decision result is No, S11407 through S11410 are executed.

In S11404, for each datetime, the distance calculator 114 calculates the distance (for example, a difference between feature amounts) between the real performance load and the forecasted performance load.

In S11405, for each datetime, the distance calculator 114 decides a Boolean true value for the datetime in the case where the distance calculated in S11404 exceeds the distance threshold obtained in S11401. In contrast, the distance calculator 114 decides a Boolean false value for the datetime in the case where the distance calculated in S11404 is less than or equal to the distance threshold obtained in S11401. In this manner, a Boolean series made up of a plurality of Boolean values corresponding to the plurality of datetimes is created.

In S11406, the distance calculator 114 adds the created Boolean series to the log DB 130 (point-based distance result list in the window outlier table 131).

In S11407, the distance calculator 114 converts each of the real windows (real time series datasets) and forecast windows (forecasted time series datasets) to a distribution summarized using the same processing function. A distribution corresponding to the real window is referred to as a “real distribution,” and a distribution corresponding to the forecast window is referred to as a “forecasted distribution.” Each of these distributions may be a histogram having the same bin size, for example. The bin size (width of a bin) may be the range of performance load, and the bin length may be the number of performance loads belonging to this range. Specifically, for example, the bin size is a fixed width (for example, 10), and a plurality of bins are prepared in such a manner as to correspond with the performance load range (for example, a CPU usage rate is between 0% through 100%, therefore 10 bins are necessary).

In S11408, the distance calculator 114 calculates a distance between the real distribution and the forecasted distribution.

In S11409, the distance calculator 114 returns a Boolean true value in the case where the distance calculated in S11408 exceeds the distance threshold obtained in S11401. In contrast, the distance calculator 114 returns a Boolean false value in the case where the distance calculated in S11408 is less than or equal to the distance threshold obtained in S11401.

In S11410, the distance calculator 114 adds the Boolean value returned in S11409, to the log DB 130 (distribution-based distance result list in the window outlier table 131).

In the above manner, the distance calculator 114 performs a point-based or distribution-based outlier sub-detection from the perspective of the distance between the real time series dataset and the forecasted time series dataset.

For each type of outlier sub-detector described above, it is possible to perform a point-based outlier detection or a distribution-based outlier detection, but it may be that one type of these outlier detections is not performed.

For a parameter set including the point/distribution-based classifier “point,” a point-based outlier sub-detection is, based on each measured value in a real time series dataset and each forecasted value in a forecasted time series dataset, detecting whether each measured value in the real time series dataset is an outlier candidate. In the case of an outlier candidate, a Boolean true value is outputted for the measured value which is the outlier candidate.

By virtue of the point-based outlier sub-detection, it is known whether or not there is an outlier candidate for each real performance load. A point-based forecasted spike detection (S11204 through S11206 in FIG. 7) is as described with reference to FIG. 15. By virtue of point-based direction calculations (S11304 and S11305 in FIG. 8), it is possible to remove a real performance load which is less than or equal to the forecasted performance load from outlier candidates. By virtue of point-based distance calculations (S11404 through S11406 in FIG. 9), it is possible to remove a real performance load for which the distance to the forecasted performance load is less than or equal to the distance threshold from outlier candidates.

By virtue of a distribution-based outlier sub-detection, whether or not there are outlier candidates is known for the entirety of a real time series dataset. A distribution-based forecasted spike detection (S11207 through S11211 in FIG. 7) is as described with reference to FIG. 16. By virtue of the distribution-based direction calculations (S11306 through S11308 in FIG. 8), it is possible to assume that there are no outlier candidates if the ratio of real performance loads exceeding the forecasted performance load is less than or equal to the direction threshold. By virtue of distribution-based distance calculations (S11407 through S11410 in FIG. 9), it is possible to assume that there are no outlier candidates for a real time series dataset corresponding to a real distribution for which distance between a forecasted distribution is less than or equal to the distance threshold.

The log DB 130 stores the window outlier table 131 exemplified in FIG. 10A, the outlier decision table 132 exemplified in FIG. 10B, and the threshold table 133 exemplified in FIG. 10C.

As illustrated in FIG. 10A, the window outlier table 131 has columns such as a window datetime identifier D13101, a point-based distance result list D13102, a point-based direction result list D13103, a point-based spike result list D13104, a distribution-based distance result list D13105, a distribution-based direction result list D13106, and a distribution-based spike result list D13107, for example.

The window datetime identifier D13101 stores a window datetime identifier (for example, a value representing a start datetime for the time period for a real window length) allocated to a real window.

The point-based distance result list D13102 stores a list of Boolean series outputted in point-based distance calculations. The point-based direction result list D13103 stores a list of Boolean series outputted in point-based direction calculations. The point-based spike result list D13104 stores a list of Boolean series outputted in point-based expected spike detections. Regarding each of these lists D13102 through D13104, there is a Boolean series for each window datetime identifier (for each window set which includes a real window identified from the window datetime identifier). For each window datetime identifier, the point-based Boolean series is made up of a plurality of Boolean values corresponding to the plurality of datetimes which make up a time period having the length of the processing window corresponding to the window datetime identifier.

The distribution-based distance result list D13105 stores Boolean values outputted in distribution-based distance calculations. The distribution-based direction result list D13106 stores Boolean values outputted in distribution-based direction calculations. The distribution-based spike result list D13107 stores Boolean values outputted in distribution-based expected spike detections. Regarding each of these lists D13105 through D13107, there is a Boolean series for each window datetime identifier (for each window set which includes a real window identified from the window datetime identifier). For each window datetime identifier, the distribution-based Boolean series is made up of one Boolean value outputted for the processing window corresponding to the window datetime identifier.

As illustrated in FIG. 10B, the outlier decision table 132 includes columns such as a window datetime identifier D13201, an outlier Boolean value D13202, a noise Boolean value D13203, an expected spike Boolean value D13204, an aligned Boolean value 13205, and a log message D13206, for example.

The window datetime identifier D13201 stores a datetime identifier allocated to a real window.

The outlier Boolean value D13202 stores a Boolean true value as a result value in a case where identification as an outlier is made for a real window (and stores a Boolean false value otherwise).

The noise Boolean value D13203 stores a Boolean true value as a result value in a case where identification as a noisy outlier is made for a real window (and stores a Boolean false value otherwise).

The expected spike Boolean value D13204 stores a Boolean true value as a result value in a case where identification as a noisy outlier is made for a real window on the basis of an expected spike expressed by forecasted time series data (and stores a Boolean false value otherwise).

The aligned Boolean value D13205 stores a Boolean true value as a result value in a case where a real window is evaluated based on a parameter including a sliding alignment length which is not zero (and stores a Boolean false value otherwise). In addition to or in place of a Boolean value, the aligned Boolean value D13205 can also store information representing a sliding alignment length used and a direction for alignment (in other words, information including information regarding whether the real window is relatively earlier or later than the forecast window and information representing a time difference between these windows).

The log message D13206 stores text messages stating several items of information discovered during an outlier detection processing from data pertaining to the state of the IT system, for example, whether a value is an outlier, is a noisy outlier, or is not an outlier, and further stating additional detailed information as necessary.

As illustrated in FIG. 10C, the threshold table 133 includes columns such as threshold information D13301 and a value D13302, for example.

The threshold information D13301 stores a description (for example, information for convenience or later reference) for each type of additional threshold information calculated in the noise reducing outlier detection apparatus 100. As threshold information, there is a spiking load threshold, a point-based alignment list, and a distribution-based alignment list, for example.

The value D13302 stores data values allocated according to statements in the threshold information D13301.

FIG. 11A and FIG. 11B are flow charts illustrating an example of a flow for outlier decision processing. The outlier decision processing is performed by the outlier decider 140. The outlier decision processing includes using processing results by all the outlier sub-detectors 112 to 114 in the outlier detector 110 to finally decide an outlier. The outlier decision processing may include creating a necessary log message which can be outputted to the display 400.

In S14001, the outlier decider 140 refers to the parameter/threshold DB 300, and evaluates all point-based entries (all entries including the point/distribution-based classifier “point”). In a case where there is a point-based entry which includes a sliding alignment length that is not “0,” the outlier decider 140 adds a Boolean true value to the point-based alignment list in the threshold table 133 in the log DB 130 (and adds a Boolean false value otherwise). As one example, as in the example in FIG. 10C, a Boolean false value ([0]) is recorded in the point-based alignment list for a point-based entry that includes the sliding alignment length “0.” Further, in the case where, as a point-based entry, in addition to a point-based entry which includes the sliding alignment length “0,” there is a point-based entry which includes a sliding alignment length other than “0,” a Boolean true value is appended to the point-based alignment list in the threshold table 133 (as a result, the list becomes [0, 1]).

In S14002, the outlier decider 140 refers to the parameter/threshold DB 300, and evaluates all distribution-based entries (all entries including the point/distribution-based classifier “distribution”). In a case where there is a distribution-based entry which includes a sliding alignment length that is not “0,” the outlier decider 140 adds a Boolean true value to the distribution-based alignment list in the threshold table 133 in the log DB 130 (and adds a Boolean false value otherwise). As one example, as in the example in FIG. 10C, a Boolean true value ([1]) is therefore recorded in the distribution-based alignment list for a distribution-based entry that includes a sliding alignment length which is not “0.” Further, in the case where, as a distribution-based entry, in addition to a distribution-based entry which includes a sliding alignment length other than “0,” there is a distribution-based entry which includes a sliding alignment length of “0,” a Boolean false value is appended to the distribution-based alignment list in the threshold table 133 (as a result, the list becomes [1, 0]).

In S14003, the outlier decider 140 obtains the window outlier table 131 from the log DB 130. S14004 through S14016 are executed for each window datetime identifier in the window outlier table 131. S14004 through S14006 may be executed in parallel with S14007. In addition, S14004 through S14006 are performed for each point-based entry for which the Boolean value in the corresponding point-based alignment list is “0” (false) (in other words, for each point-based entry which includes the sliding alignment length of “0”). The description of S14004 through S14006 takes, as an example, one window datetime identifier and one point-based entry (a point-based entry which includes a sliding alignment length of “0”). The description of S14007 takes one window datetime identifier as an example.

In S14004, the outlier decider 140 outputs a single point-based Boolean series by calculating an AND-relationship for all point-based Boolean series in the window outlier table 131 (in other words, the point-based distance, direction, and spike result lists). For example, in a case where the Boolean value in all point-based Boolean series is “1” for one datetime, the Boolean value in a single point-based Boolean series becomes “1” for this datetime. In contrast, in a case where the Boolean value is “0” in all point-based Boolean series for one datetime or in a case where “1” and “0” is mixed as Boolean values in the point-based Boolean series for one datetime, the Boolean value in a single point-based Boolean series for the datetime becomes “0.”

In S14005, for the single Boolean series obtained in step S14004, the outlier decider 140 calculates a Boolean true value occurrence rate (a ratio of Boolean true values in the single Boolean series with respect to the number of Boolean values that make up the single Boolean series). For example, in a case where the window length is “5” data points (a case where the number of datetimes (times) belonging to one processing window is “5”), the Boolean series outputted in S14004 is made up of five Boolean values. In a case where the Boolean series is [1, 0, 1, 0, 1], the Boolean true value occurrence rate calculated in S14005 is 60%.

In S14006, in a case where the occurrence rate obtained in step S14005 is greater than the occurrence rate threshold in the parameter/threshold DB 300 (occurrence rate threshold corresponding to the entry ID of the point-based entry), the outlier decider 140 returns a Boolean true value (and otherwise returns a Boolean false value). For example, in a case where the Boolean true value occurrence rate calculated in S14005 is 60% and the occurrence rate threshold is 70%, the occurrence rate is smaller and thus a Boolean false value is outputted.

In S14007, for a distribution-based entry for which the Boolean value in the corresponding distribution-based alignment list is false (a distribution-based entry which includes a sliding alignment length of “0”), the outlier decider 140 outputs a single distribution-based Boolean series by calculating an AND-relationship between all distribution-based Boolean series in the window outlier table 131 (in other words, the distribution-based distance, direction, and spike result lists). In distribution-based processing, because there is one Boolean value as an outlier sub-detection result for one processing window, the Boolean series outputted in S14007 is made up of a single Boolean value.

In S14008, the outlier decider 140 calculates an AND-relationship between the point-based output which is the output of the loop of S14004 through S14006 and the distribution-based output which is the output of S14007, and finally returns an outlier Boolean value as a result. In other words, in S14008, an AND-relationship is calculated between the single Boolean value as the point-based output and the single Boolean value as the distribution-based output.

In S14009, the outlier decider 140 decides whether or not the final outlier Boolean value is true. In a case where the decision result is Yes, the processing proceeds to S14010. In a case where the decision result is No, the processing proceeds to S14014. In addition, it may be that, in a case where there is no point-based or distribution-based target which has a false value in an alignment list in the threshold table 133, the processing proceeds to S14010.

In S14010, the outlier decider 140 decides whether or not any point-based or distribution-based alignment list in the threshold table 133 in the log DB 130 has a true value. In a case where the decision result is Yes, the processing proceeds to S14011. In a case where the decision result is No, the processing proceeds to S14013.

In S14011, the outlier decider 140 calculates an AND-relationship between all point-based occurrence rate evaluation results corresponding to point-based or distribution-based alignment lists having a true value (lists in the threshold table 133) and the distribution-based Boolean result (Boolean series which is the output in S14007), and returns a result of the calculation as an outlier Boolean value output. A detailed AND-relationship calculation is not described here, but may be a calculation similar to that for S14004 through S14008 described above, for example. For example, a Boolean series which is all point-based occurrence rate evaluation results corresponding to point-based or distribution-based alignment lists having a true value may be calculated similarly to in S14004 through S14008. Note that a difference between S14008 and S14011 is as follows. In other words, S14008 is processing for entries where the sliding alignment length is “0” (processing for cases where sliding alignment is not performed), but S14011 is processing for where the sliding alignment length is not “0” (processing for cases where sliding alignment is performed).

In S14012, the outlier decider 140 decides whether or not the outlier Boolean value obtained in S14011 is true. In a case where the decision result is Yes, the processing proceeds to S14013. In a case where the decision result is No, the processing proceeds to S14015.

In S14013, the outlier decider 140 calculates a severeness of an outlier from known time series information, and stores a log message and the outlier Boolean value in the log DB 130 (outlier decision table 132). For example, using a window datetime identifier for a processing window which is currently being considered (for example, a rolling window) and a real time series dataset and a forecasted time series dataset for the corresponding processing window, the outlier decider 140 can quantify the difference between a real performance load and a forecasted performance load. The outlier decider 140 may then create a log message on the basis of this quantified information. Further, it may be that the outlier decider 140 observes an expected spike present in a time period corresponding to the processing window and specifies a real time series dataset classified as an abnormal value because the actually observed spiking load is sufficiently longer than a forecasted expected spike.

In S14014, the outlier decider 140 tests whether or not there is a noisy outlier for a processing window (time frame currently being considered) identified as a non-outlier without having been subjected to sliding alignment. For example, it may be that, in a case where a distance- or direction-based outlier is identified as a non-outlier due to an expected spike, a noisy outlier is observed. It may be that the outlier decider 140 provides information such as by how much larger or smaller the real time series is than the forecasted time series or information pertaining to a difference between the lengths observed for an expected spike between a forecasted time series and a real time series and creates a log message giving a warning regarding a noisy outlier. Here, in response to a test result, the outlier decider 140 may decide a false value as an aligned Boolean value and decide a true value or a false value as an expected spike Boolean value.

In S14015, the outlier decider 140 identifies a noisy outlier (a non-outlier for which sliding alignment has been performed) for the processing window (the time frame currently being considered). In this case, the datetime identifier of such a processing window is identified as an outlier in S14009, and subsequently identified as a non-outlier in consideration of sliding alignment in S14012. Accordingly, it is understood that the outlier identified in S14009 is a noisy outlier. Further, the outlier decider 140 may test whether or not a non-outlier for this processing window is a noisy outlier according to an expected spike. The outlier decider 140 may then create a log message which gives a warning regarding a real spike which is earlier or later than an expected spike, for example. Here, in response to a test result, the outlier decider 140 may decide a true value as an aligned Boolean value and decide a true value or a false value as an expected spike Boolean value.

In S14016, the outlier decider 140 stores an outlier Boolean value, a noise Boolean value, an expected spike Boolean value, an aligned Boolean value, and the created log message in the outlier decision table 132 in the log DB 130. The outlier Boolean value and the noise Boolean value are values according to the at least one result from S14009 and S14012. The expected spike Boolean value, the aligned Boolean value, and the created log message have the values that are the results in S14014 or S14015.

In S14017, the outlier decider 140 analyzes real outliers and noisy outliers (for example, performs analysis in relation to a large context which is a time period corresponding to several consecutive processing windows). For example, this analysis is performed on the basis of the outlier Boolean value, the noise Boolean value, the expected spike Boolean value, and the aligned Boolean value in the log DB 130 (outlier decision table 132). For example, regarding a real outlier (a performance load in a processing window corresponding to where the outlier Boolean value is “1” and the noise Boolean value is “0” or “None”), it may be that the outlier decider 140 specifies additional information such as a continuous amount of time for the real outlier. In addition, for example, regarding a noisy outlier (a performance load in a processing window corresponding to where the noise Boolean value is “1”), it may be that the outlier decider 140 identifies an expected spike occurrence pattern and how large a real spike is in comparison to an expected spike, on the basis of the expected spike Boolean value and the aligned Boolean value, for example. The magnitude of a real spike may be specified from real time series data, on the basis of a datetime identifier (and the magnitude of a sliding alignment) corresponding to a noisy outlier. The magnitude of an expected spike may be specified from forecasted time series data, on the basis of a datetime identifier (and the magnitude of a sliding alignment) corresponding to a noisy outlier. In S14017, it may be that the outlier decider 140 creates a log message based on an analysis result and stores the log message in the log DB 130.

FIG. 12 illustrates an example of an outlier detection result screen.

An outlier detection result screen 1200 is a graphical user interface (GUI) which is displayed on the display 400 by the noise reducing outlier detection apparatus 100. Display content in the outlier detection result screen 1200 may be periodically (for example, frequently) updated by obtaining all log messages, outliers, and time series information from the log DB 130 and the time series DB 200, for example.

The outlier detection result screen 1200 has a graphical visualization area 401 and a log message output area 402.

A time series for a real performance load and a forecasted performance load are displayed in the graphical visualization area 401 as a graph, for example, on the basis of real time series data and forecasted time series data in the time series DB 200. In addition, it may be that an outlier occurrence period of time (for example, a consecutive range of datetime identifiers corresponding to where the outlier Boolean value is “1” and the noise Boolean value is “0” or “None”) which is specified on the basis of the log DB 130 (for example, the outlier decision table 132) is displayed in the graphical visualization area 401.

Log text messages stored in the log DB 130 are displayed in the log message output area 402 as descriptive and alternative outputs for the display in the graphical visualization area 401.

The outlier detection result screen 1200 may be a UI that is not a GUI. In addition, it may be that a display area included in the outlier detection result screen 1200 is not limited to the graphical visualization area 401 and the log message output area 402, these display areas may be separated into two or more areas or may be made to be one display area, or each display area may be disposed at any position.

In processing indicated in FIG. 11A and FIG. 11B, a log message may be created in a case where an outlier is detected or in a case where a non-outlier (for example, a noisy outlier) is detected. As a result, as in the example in FIG. 12, if log messages are displayed, for example, an operator can distinguish whether a normal real performance load at a certain datetime is normal because this normal real performance load has been detected as a noisy outlier or has been originally normal but has not been detected as a noisy outlier. Note that the log messages may include a message representing what kind of outlier detection result has been obtained through which steps (through which steps in the flow chart described above).

FIG. 13 illustrates an example of a hardware configuration of the noise reducing outlier detection apparatus 100.

The noise reducing outlier detection apparatus 100 is, for example, a typical computer, and has a memory 502, an auxiliary storage device 503, a communication interface 504, a media interface 505, an input/output device 506, and a CPU 501 which is connected to these. The interfaces 504 through 506 are each an example of an interface device. The CPU 501 is an example of a processor.

The communication interface 504 is an interface device for communicating with another apparatus (for example, an external database storing data to be analyzed) via a network 508.

The memory 502 is a random-access memory (RAM), for example, and stores programs executed by the CPU 501, data, etc. The auxiliary storage device 503 is, for example, an HDD or an SSD, and stores programs executed by the CPU 501, data used by the CPU 501, etc. An external storage medium 507 can be attached to and detached from the media interface 505, and the media interface 505 intermediates input and output of data to and from the external storage medium 507.

A console 500 is connected to the input/output device 506, and the input/output device 506 inputs and outputs information to and from the console 500. The console 500 includes the display 400, for example.

The CPU 501 executes a program stored in the memory 502 or the auxiliary storage device 503, and uses data stored in the memory 502 or the auxiliary storage device 503 to execute various processing.

Each function implemented in the noise reducing outlier detection apparatus 100 may be realized by the CPU 501 executing a program stored in the auxiliary storage device 503 or the memory 502. Information such as the DBs or tables described above is stored in at least one of the memory 502, the auxiliary storage device 503, the external storage medium 507, and an external storage apparatus which can be accessed via the network 508.

Description is given above for one embodiment, but this is one example for describing the present invention, and the scope of the present invention is not limited to only this embodiment. The present invention can be implemented in various other forms.

For example, the noise reducing outlier detection apparatus 100 may be employed in a use case of operating and managing an IT system, but the noise reducing outlier detection apparatus 100 may also be employed in another use case where similar data analysis according to comparison between real time series data and forecasted time series data is possible. In addition, for example, loop processing for each window set may be performed in parallel.

In addition, for example, it may be that at least one of point-based processing and distribution-based processing does not have one outlier sub-detection from among an expected spike detection, a direction calculation, and a distance calculation or employs a different kind of outlier sub-detection in place of or in addition to at least one outlier sub-detection from among an expected spike detection, a direction calculation, and a distance calculation.

In addition, for example, the outlier detector 110 (the expected spike detector 112) may automatically decide whether to perform a point-based or distribution-based expected spike detection. Specifically, for example, in a case where data representing an event for which the difference between spike occurrence timings is small (for example, data representing that the difference between a predetermined start datetime for predetermined processing and the real start datetime is less than or equal to a tolerance) is inputted to the outlier detector 110, the outlier detector 110 (the expected spike detector 112) may decide to perform a point-based expected spike detection. In a case where data representing an event for which the difference between spike occurrence timings is large (for example, data representing that the difference between a predetermined start datetime for predetermined processing and the real start datetime exceeds a tolerance) is inputted to the outlier detector 110, the outlier detector 110 (the expected spike detector 112) may decide to perform a distribution-based expected spike detection.

In addition, for example, the sliding alignment length may be automatically decided by the outlier detector 110 (the expected spike detector 112) on the basis of data representing the difference between a scheduled datetime and a real datetime (for example, data representing the difference between a predetermined start datetime for predetermined processing and a real start datetime).

In addition, for example, it may be that only one type of outlier sub-detector is prepared. In addition, for example, it may be that there is only one entry ID (refer to FIG. 3A and FIG. 3B) prepared from real time series data and forecasted time series data. In other words, it may be that only one of point-based processing and distribution-based processing is performed for these items of time series data. For example, in a case where there is only one type of outlier sub-detector and only one entry ID, it may be that output from the outlier sub-detector is the output from the outlier decider 140. In addition, there may be a plurality of entry IDs for at least one of point-based processing and distribution-based processing. In addition, other types of information may be employed in place of or in addition to Boolean values, as output from each outlier sub-detector.

What is claimed is:

1. An outlier detection apparatus comprising:
an outlier detector; and
an outlier decider,
wherein the outlier detector has a window creator and one or a plurality of types of outlier sub-detectors,
the window creator creates a first processing window having a designated window length and a second processing window having a designated window length, and performs sliding alignment for sliding the second processing window relative to the first processing window by a designated sliding alignment length,
each of one or more types of outlier sub-detectors from among the one or a plurality of types of outlier sub-detectors performs an outlier sub-detection which includes comparing, by a method corresponding to the type of the outlier sub-detector, a real time series dataset which is a data portion corresponding to the first processing window from among real time series data which is a time series of real values, with a forecasted time series dataset which is a data portion corresponding to the second processing window after the sliding alignment from among forecasted time series data which is a time series of forecasted values, and
the outlier decider decides whether an outlier candidate based on an outlier sub-detection result from the one or more types of outlier sub-detectors is an outlier.

2. The outlier detection apparatus according to claim 1, wherein
each of the one or more types of outlier sub-detectors performs a distribution-based outlier sub-detection which is using information based on an entirety of the real time series dataset and information based on an entirety of the forecasted time series dataset to detect whether there is an outlier candidate in the real time series dataset.

3. The outlier detection apparatus according to claim 2, wherein
there are a plurality of parameter threshold sets for the real time series data and the forecasted time series data,
each of the plurality of parameter threshold sets has a parameter set including a window length and a sliding alignment length, and a threshold set including one or more thresholds used in an outlier sub-detection, and,
for each of the plurality of parameter threshold sets,
the window creator creates a first and second processing windows each having a window length in the set, and, in relation to the created first and second processing windows, performs sliding alignment according to a sliding alignment length in the parameter set,
each of the one or more types of outlier sub-detectors among the one or a plurality of types of outlier sub-detectors performs a distribution-based outlier sub-detection with use of a threshold in the set, and
the outlier decider decides, based on an outlier sub-detection result from the one or more types of outlier sub-detectors, the result being obtained for each of the plurality of parameter sets, whether an outlier candidate is an outlier.

4. The outlier detection apparatus according to claim 3, wherein
the plurality of parameter sets in the plurality of parameter threshold sets include a point/distribution-based classifier representing which of point-based or distribution-based processing to perform, and,
for each of the plurality of parameter threshold sets, an outlier sub-detector
performs, in a case where the point/distribution-based classifier in the set represents distribution-based processing, a distribution-based outlier sub-detection, and
performs, in a case where the point/distribution-based classifier in the set represents point-based processing, a point-based outlier sub-detection which is detecting whether each real value in the real time series dataset is an outlier candidate, on a basis of a threshold in the set, each real value in a real time series dataset corresponding to the first processing window having the window length in the set, and each forecasted value in a forecasted time series dataset corresponding to the second processing window having the window length.

5. The outlier detection apparatus according to claim 2, wherein
the one or more types of outlier sub-detectors include a first type of outlier sub-detector, and
the first type of outlier sub-detector
specifies, from among the real time series dataset, a first number which is the number of real values larger than a value threshold decided on a basis of the forecasted time series data,
specifies a second number which is the number of forecasted values larger than the value threshold,
calculates, as a distribution-based comparison, a ratio of the first number to the second number, and
detects whether there is an outlier candidate in the real time series dataset, according to a magnitude of the calculated ratio.

6. The outlier detection apparatus according to claim 2, wherein
the one or more types of outlier sub-detectors include a second type of outlier sub-detector, and
the second type of outlier sub-detector
specifies the number of real values larger than a forecasted value by comparing the real time series dataset with the forecasted time series dataset,
calculates a ratio of the specified number with respect to the number of real values in the real time series dataset, and
detects whether there is an outlier candidate in the real time series dataset, according to a magnitude of the calculated ratio.

7. The outlier detection apparatus according to claim 2, wherein
the one or more types of outlier sub-detectors include a third type of outlier sub-detector, and
the third type of outlier sub-detector
specifies a first distribution which is a distribution of the real time series dataset,
specifies a second distribution which is a distribution of the forecasted time series dataset,
calculates a distance between the first distribution and the second distribution, and
detects whether there is an outlier candidate in the real time series dataset, according to a magnitude of the calculated distance.

8. The outlier detection apparatus according to claim 1, wherein
each of the one or more types of outlier sub-detectors performs a point-based outlier sub-detection which is, on a basis of each real value in the real time series dataset and each forecasted value in the forecasted time series dataset, detecting whether each real value in the real time series dataset is an outlier candidate.

9. The outlier detection apparatus according to claim 8, wherein
the one or more types of outlier sub-detectors include a first type of outlier sub-detector, and
the first type of outlier sub-detector
specifies, from among the forecasted time series dataset, a forecasted value larger than a value threshold decided on a basis of the forecasted time series data, and
excludes, from among the real time series dataset, a real value corresponding to the specified forecasted value from an outlier candidate, and sets other real values as real value candidates.

10. The outlier detection apparatus according to claim 8, wherein
the one or more types of outlier sub-detectors include a second type of outlier sub-detector, and
the second type of outlier sub-detector
sets, from among the real time series dataset, a real value larger than a forecasted value as an outlier candidate, and excludes a real value less than or equal to a forecasted value as an outlier candidate.

11. The outlier detection apparatus according to claim 8, wherein
the one or more types of outlier sub-detectors include a third type of outlier sub-detector, and
the third type of outlier sub-detector
calculates, for each datetime, a distance between a real value in the real time series dataset and a forecasted value in the forecasted time series dataset, and
detects, for each datetime, whether the real value corresponding to the datetime in the real time series dataset is an outlier candidate, according to a magnitude of the calculated distance.

12. The outlier detection apparatus according to claim 1, wherein
each of the one or more types of outlier sub-detectors outputs information representing a result of an outlier sub-detection to log information,
the outlier decider outputs information representing a decision result of whether an outlier candidate is decided to be an outlier to the log information,
information outputted to the log information includes a log message pertaining to a result of the detection or the decision, and,
on a basis of the log information, result information including an outlier decision result and a log message is displayed.

13. The outlier detection apparatus according to claim 3, wherein,
for each of the plurality of parameter threshold sets, the outlier sub-detector performs, on a basis of the set, one of a distribution-based outlier sub-detection and a point-based outlier sub-detection which is detecting whether each real value in a real time series dataset is an outlier candidate,
the outlier sub-detector,
in a case where there is one or more point-based outlier sub-detection results, calculates one outlier sub-detection result which is an AND of the one or more outlier sub-detection results, and calculates one point-based result value on a basis of an occurrence rate which is a ratio of values meaning that there is an outlier candidate in the one outlier sub-detection result,
in a case where there is one or more distribution-based outlier sub-detection results, calculates one distribution-based result value which is an AND of the one or more outlier sub-detection results, and
decides whether or not an outlier candidate is an outlier on a basis of the one point-based result value and the one distribution-based result value.

14. An outlier detection method comprising:
creating, by a computer, a first processing window having a designated window length and a second processing window having a designated window length;
performing, by the computer, a sliding alignment for sliding the second processing window relative to the first processing window by a designated sliding alignment length; and
performing, by the computer, one or more types of outlier sub-detections from among one or a plurality of types of outlier sub-detections,
each of the one or more types of outlier sub-detections including comparing, by a method corresponding to the type of outlier sub-detection, a real time series dataset which is a data portion corresponding to the first processing window from among real time series data which is a time series of real values, with a forecasted time series dataset which is a data portion corresponding to the second processing window after the sliding alignment from among forecasted time series data which is a time series of forecasted values; and
deciding, by the computer, whether an outlier candidate based on a result of the one or more types of outlier sub-detections is an outlier.
